(19) United States
(12) Patent Application Publication
(10) Pub. No.: US 2005/0197919 A1
(43) Pub. Date: Sep. 8, 2005

(54) System and method for providing electronic multi-merchant gift certificate & contribution brokering services over a distributed network

(76) Inventor: Steven C. Robertson, Kent, WA (US)

Correspondence Address: PATRICK M. DWYER PC, 1818 WEST LAKE AVENUE N, SUITE 114, SEATTLE, WA, 98109-2707, US

(21) Appl. No.: 11/036,183

(22) Filed: Jan. 13, 2005

Related U.S. Application Data
(62) Division of application No. 09/324,601, filed on Jun. 2, 1999.

(51) Int. Cl. G06F 17/60

(52) U.S. Cl. 705/26

(57) ABSTRACT

An online Gift Certificate and Contribution Service provides for the purchase and restrictions of use of electronic gift certificates, which may be split across multiple purchases at a plurality of merchants. It allows online purchases to be made by individuals unable to obtain (such as children) or prefer not to obtain a credit card. In addition, electronic contributions can be made on a one-time basis or a reoccurring basis to designated beneficiaries anonymously if desired. It provides a streamlined checkout process whereby the purchaser may place restrictions on the use of the gift certificate. Users and Merchants initially register with the Gift Certificate Service and are provided additional functionality. For users, the ability to purchase electronic gift certificates, place restrictions on their use, and track their use is provided. In addition, users may setup contribution accounts to contribute anonymously to beneficiaries. For merchants, the ability to validate the gift certificate is provided. A distinct advantage of this system is that it allows parents to give gift certificates in lieu of allowance and be able to restrict and track purchases. Another significant advantage is that a single gift certificate can be used on multiple occasions and at a plurality of merchants. The advantage of the contribution service is that transactions can take place anonymously and on a reoccurring basis automatically.

### TECHNICAL FIELD

The invention relates to brokering services over a distributed network; more particularly, it relates to method and system for providing multi-merchant gift certificate and contribution brokering services over a distributed network; further and more particularly, it relates to an online gift certificate and contribution broker that allows consumers to purchase gift certificates that may be redeemed at any participating electronic merchant.

### BACKGROUND OF THE INVENTION

In the United States, gift certificates have been an easy way to purchase gifts for individuals while giving the individual a choice in what they would like to receive. Companies have used gift certificates to reward their employees and individuals have used them for gifts for their friends, family, and business associates. In addition, many companies use them as promotional gifts for awards and marketing research.

For the gift giver, a gift certificate allows a quick, convenient, and easy method of purchasing a gift for someone else without knowing exactly what he or she is looking for or desires. This is especially important in today's society due to increasing time constraints on a busy executive's time.

For the gift receiver, a gift certificate allows a choice of items and easier returns since they will have a receipt, unlike if they received a gift directly.

Traditionally, gift certificates could only be purchased through retail establishments or through mail-order catalogs. This still was inconvenient because it usually meant traveling to the retail establishment to purchase the gift certificate.

A more recent partial solution, which exploits the low cost and wide availability of the Internet, has been for some Merchant specific Internet sites to host their own content as World Wide Web sites (“Web” or “WWW” sites), which can be accessed by consumers “directly” via the Internet. With this approach, a few, very progressive online merchants, have recently started offering gift certificates for their products. For example, Amazon.com sells gift certificates, which can be used for purchases at their site. A major limitation of this approach is that once purchased, the gift certificate can only be used at that merchant. Another limitation of this approach is that the gift giver cannot place any restrictions on the use of the gift certificate. An even further limitation is that they typically can only be used for one purchase and thus you lose any value that wasn't used on that purchase.

The present invention involves the problem of allowing individuals to purchase a gift certificate that is not restricted to a single merchant, but may be used on multiple occasions and at multiple online business entities, referred to herein as Merchants.

While the idea of gift certificates has met with tremendous acceptance in the marketplace, there is a continued need for a multi-merchant gift certificate that allows for individuals to use the gift certificate at different merchants and even distribute the value of the certificate across multiple merchants. Furthermore, there is a great need to be able to place restrictions on the use of the gift certificates. For example, parents could give gift certificates in lieu of allowance and restrict the types of purchases that their children may make. Another example is that charity organizations may restrict the use of these gift certificates for food & clothing only to prevent the misuse of funds for things like alcohol or cigarettes.

### DISCLOSURE OF THE INVENTION

The present invention provides a system and method in which Merchants host their own content as directly-accessible sites (referred to herein as “Merchant sites”) on a distributed network such as the Internet, while relying on a centralized Online Gift Certificate site (which implements an Online Gift Certificate Service) to handle gift certificate purchases and billing. The system advantageously allows gift purchasers to place restrictions on the use of the gift certificates by the recipient and administers those restrictions on behalf of the gift purchasers. These electronic gift certificates are not restricted to a specific merchant. In addition, contributions can be made anonymously to charity organizations and/or individuals on a one-time or recurring basis.

This invention provides a system for allowing gift recipients to use a digital gift certificate in lieu of payment at a plurality of participating merchants. These merchants would in turn, verify the owner of the gift certificate and the required amount available with the Gift Certificate site. Once approved, similar to a credit card transaction, the amount of the transaction would be deducted from the available amount left for the gift certificate at the Gift Certificate site. The user may then use any remaining amount at the same or other merchants. If the amount of credit is less than the purchase amount, the Merchant may allow another form of payment such as a credit card to make up the difference.

Another embodiment of this invention is that the digital gift certificate may act as a credit account, where multiple gift givers may contribute to this account either on a one-time basis or on a reoccurring basis. This type of account would provide reports on how, when, where, and on what the gift certificates were used for. Due to privacy reasons, these types of accounts would be limited to special relationships such as adult parents with their children.

This invention provides a system for a gift giver to purchase a gift certificate that may be used at a plurality of participating merchants. The gift certificate purchaser if desired, may optionally place restrictions, on the use of the gift certificate. Some limitations may include, but is not limited to a) Product Category (e.g. Food, clothing, etc.); b) Product Age Range; c) Maximum amount in 1 transaction; d) Maximum amount per week; or e) Maximum amount per month. The gift purchaser may also restrict the use by categories of merchants or only sites with certain ratings. Also, they may restrict the shipping address to a given location.

In a preferred embodiment the Merchant sites are in the form of Web sites on the Internet, and the gift recipient uses these gift certificates at participating merchants by selecting them as the form of payment when placing an order. These Web sites provide mechanisms for validating authorization and for sending purchase transaction information back to the Gift Certificate site. The authorization process would submit not only the requested dollar amount, but also other information such as type of products so that the Gift Certificate site may administer any restrictions placed on the gift certificate. In addition, purchased information would include products purchased, by whom, where shipped, date of order, and other necessary information to allow the Gift Certificate site to track the use of the gift certificate on behalf of the purchaser if appropriate.

The system and method of invention are advantageously suited for use over an unsecured public network such as the Internet. In general, however, the system and method can be used on any type of distributed network over which Merchants provide online services to users. This may include both trusted and un-trusted networks and public, private, or hybrid public-private networks.

In accordance with the invention, users (consumers) that wish to make use of the Online Gift Certificate Service initially register with the Brokering Service, and are in-turn provided with any client software components needed to make use of the Gift Certificate Service. Upon registration, users provide account information to the Gift Certificate Broker such as payment information (e.g. credit card number), name, address, and phone number. This information is maintained in a brokering database at the Gift Certificate site, and is not exposed to the Merchants or any un-authorized person. Each user additionally selects a password, and is assigned a unique ID, which is used for authentication purposes.

In operation, a registered user may purchase digital gift certificates in any dollar amount and may optionally restrict its use to a single user or a group of specified users, or to a given company. Other restrictions may also be applied as indicated earlier. In addition, the purchaser must indicate the type of gift certificate that is being purchased. The type may be either a one-time purchase, which has an expiration date of 1 year, or a revolving account with weekly or monthly dollar amounts automatically being debited from an established account.

In addition, the gift purchaser, may instead elect that a given amount be transferred to another registered user or organization anonymously. Thus, they could contribute to a charity or political cause anonymously on a regular basis without being hassled for additional contributions.

One significant benefit of the above-described approach is that the Merchants need not be concerned with credit card fraud as their financial dealings are with the Gift Certificate Brokering Site rather than the gift certificate users. Furthermore, if the Service Provider is a charity or political organization, they may obtain monthly contributions anonymously that they would not normally receive accept through the process of this invention. The cost to a Merchant for this system would be minimal in that server-side code would be provided. In addition, industry standards would be used where applicable.

The major benefit to the gift certificate user is that they can shop anonymously if desired and have a wider variety of choices to choose from for their gift. They are also not restricted to a single merchant.

A significant benefit to the gift certificate purchaser is that of convenience and ease of use. From the comfort of their own home, they can access the system, purchase a gift certificate, and have it automatically sent to the desired recipients with a personalized message if desired or to themselves. This entire process can be accomplished in a very short amount of time as opposed to going to a retail establishment, waiting in line, and purchasing either the item or a gift certificate. Thus there is a significant timesaving.

The various embodiments and method will become more apparent on consideration of the drawings and description.

Some objects and advantages of the present invention are:
(a) to provide a system and method which allows for anonymous shopping.
(b) to provide a system and method which allows for anonymous contribution giving.
(c) to provide a system and method that allows the gift certificate purchaser to control the use of the gift certificate.
(d) to provide a system and method that provides tracking of purchases made with gift certificate.
(e) to provide a system and method whereby the gift certificate may be used at a plurality of merchants.
(f) to provide a system and method whereby the gift certificate may be used on multiple occasions.
(g) to provide a system and method whereby multiple online stores can participate.
(h) to provide a system and method that allows for a quick purchase process, which can take place in the user's home at their convenience.
(i) to provide a system and method that allows individuals that are too young for credit cards to make online purchases with pre-paid gift certificates that may be given in lieu of allowance.
(j) to provide a system and method that allows businesses to reward their employees for significant contributions made.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 illustrates the general architecture of a system, which operates in accordance with the present invention.

FIG. 2 is a flow chart representation of the steps taken by a new user, merchant, or manufacturer to register with the gift certificate system in accordance with the present invention.

FIG. 3 is a flow chart representation of the steps taken by a registered user to purchase electronic gift certificates.

FIG. 4 is a flow chart representation of the steps taken by a registered user to create a Contribution Account.

FIG. 5 is a flow chart representation of the steps taken by a registered user to modify their profile.

FIG. 6 illustrates the communications, which takes place between the Gift Certificate Authority and the registrant.

FIG. 7 is a flow chart representation of the steps taken by an individual to redeem a previously purchased gift certificate.

FIG. 8 is a flow chart representation of the steps taken by the Gift Certificate Authority in response to a Redemption Request by a Merchant for a User Purchase.

FIG. 9 is a flow chart representation of the steps taken by the Gift Certificate Authority for payment to merchants for purchases made with gift certificates.

FIG. 10 illustrates the communications, which takes place between the Gift Certificate Authority, the merchant, and the gift certificate redeemer.

FIG. 11 is a flow chart representation of the steps taken by the Gift Certificate Authority for payment to beneficiaries on behalf of a registrant.

### BEST MODE OF CARRYING OUT THE INVENTION

Turning now to the drawings, the invention will be described in a preferred embodiment by reference to the numerals of the drawing figures wherein like numbers indicate like parts.

The following is a list of reference numerals for use in browsing the drawings:
40 Internet (Or Other Public Network)
50 User Computer
52 Client Application
60 Merchant Site
62 Merchant Server Application
64 Gift Certificate Agent
70 Manufacturer Site
72 Manufacturer Server Application
80 Gift Certificate Authority Site
82 Gift Certificate Registrar
84 Contribution Account Database
86 Gift Certificate Database
88 User Database
90 Manufacturer Database
92 Merchant Database
100 Visitor Locates Gift Certificate Site
102 Visitor Makes a Request to Register
104 Gift Certificate Site Displays User Registration Form
106 Gift Certificate Site Displays Manufacturer Registration Form
108 Gift Certificate Site Displays Merchant Registration Form
110 User Provides Profile Information and Desired Authentication Information
112 Gift Certificate Site Assigns Unique Identifier to Registrant
114 Gift Certificate Site Sends an E-Mail Confirmation of Registration to the Registrant
120 Visitor Accesses Their Secured Profile
122 User Chooses to Purchase a Gift Certificate
124 Gift Certificate Site Provides Gift Certificate Purchase Form
126 User Provides Information and Submits Form
128 Gift Certificate Purchase Form Valid?
130 Validate Payment Method
132 Payment Info Approved?
134 Display Payment Error Message
136 Create New Record in Gift Certificate Database
138 Confirm Gift Certificate Purchase
140 User Chooses to Create a Contribution Account
142 Gift Certificate Site Provides Contribution Account Form
144 User Provides Information and Submits Form
146 Contribution Account Form Valid?
148 Create New Record in Contribution Database
150 Confirm Contribution Account Registration
160 Visitor Chooses to Modify Their Profile
162 Gift Certificate Site Provides Pre-populated Profile Form
164 User Provides Information and Submits Form
166 Profile Form Valid?
168 Update Record in User Database
170 Update Record in Manufacturer Database
172 Update Record in Merchant Database
174 Confirm Profile Modification
180 User Locates Merchant Site
182 User Chooses Item(s) of Interest and Checks-out
184 User Elects Gift Certificate as Form of Payment
186 Merchant Site Prompts for Gift Certificate # and PIN #
188 User Provides Gift Certificate # and PIN #
190 Authorized Purchase?
192 Display Gift Certificate Error Message
194 Fixed Address?
196 Prompt for Shipping Information
198 User Confirms Purchase
200 Merchant Sends Confirmation to Gift Certificate Authority
202 Confirmed Purchase?
204 Display Purchase Confirmation
210 Establish Secure Connection With Merchant
212 Gift Certificate Authority Receives a Request for Gift Certificate Redemption
214 Complete Information?
216 Send Error Code to Merchant Site
218 Retrieve Gift Certificate Information From Database
220 Current?
222 Set Return Status to “Expired”
224 Valid PIN?
226 Set Return Status to “Invalid Pin”
228 Sufficient Credit?
230 Set Return Status to “Insufficient Funds”
232 Passes Retrictions?
234 Set Appropriate Return Status
236 Set Return Status to “Accepted”
238 Return Status to Merchant
240 Gift Certificate System Retrieves 1st Active Merchant ID
242 Query Gift Certificate Database for Unpaid Sales Transactions for Current Merchant ID
244 Records Found?
246 Add all Unpaid Sales Transactions Totals for Records Found
248 Send Payment to Merchant
250 Mark Transactions as Paid
252 More Active Merchants?
254 Complete Payment Process
260 Retrieve 1st Contribution Accound
262 Payment Event?
264 Valid Payment Method?
266 Send E-Mail Notification of Contribution Problem
268 Submit Payment Transaction for Authorized Amount
270 Credit Authorized Amount to Beneficiary Account
272 Mark Contributor Account as Paid
274 Store Contribution Transaction with Contributor
276 Send E-Mail Confirmation of Contribution
278 More Accounts?
280 Get Next Contribution Account
282 End Contribution Process

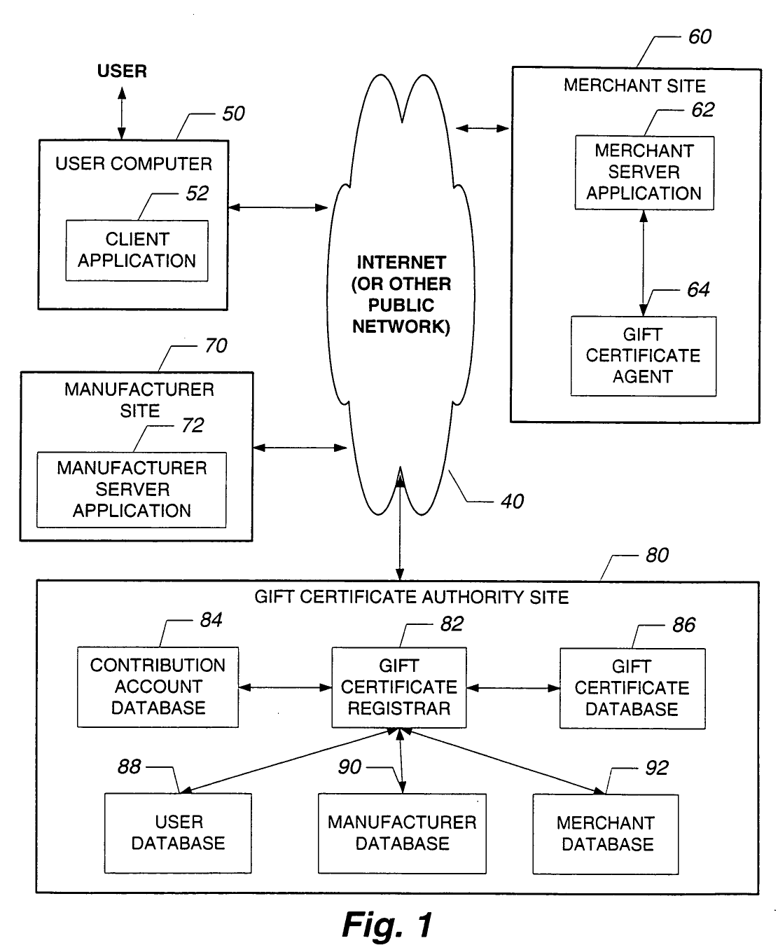

A preferred embodiment of the system architecture of the present invention is illustrated in FIG. 1.

1. Overview

In comparison to existing systems for purchasing and redeeming gift certificates, the present invention provides the following significant advantages:

1. Financial information is given to a single trusted entity.

2. Reduced Credit Card Fraud for registrants due to relationships between Gift Certificate Authority and registrants, rather than having to give financial information to unknown merchants.

3. Reduced Credit Card Fraud for merchants because the Gift Certificate Authority receives payment before issuing gift certificates. Thus merchants are guaranteed payment from the Gift Certificate Authority.

4. Quick easy purchase process, which can be done in the convenience of the individual's home rather than having to travel to a retail location for purchase. Thus, a considerable timesaving.

5. Ability for the gift certificate receiver to redeem the gift certificate at any participating merchant, thus providing more choices.

6. Ability to limit the use of the gift certificate and the types of products and services that may be purchased with it.

7. Provides for anonymous shopping, thus protecting privacy, which is a primary concern of Internet purchases.

8. Provides for anonymous contribution giving, thus encouraging individuals to contribute to more worthwhile causes on a regular basis without the hassle of sending in checks.

The system and method of the present invention are advantageously suited for use over a public network such as the Internet due to its widespread availability. (When used in herein in conjunction with “network”, the term “public” is intended to imply that user access to the network is not controlled by or limited to a particular business entity or group of business entities. Likewise, the term “distributed” implies that processing capabilities and services are spread out among different nodes of the network—as opposed to being centralized within a single host, server or LAN—with different nodes providing different services.) In general, however, the system and method can be used on any type of distributed network over which online services are provided by Merchants to end users, including both public and private, and hybrid public-private networks.

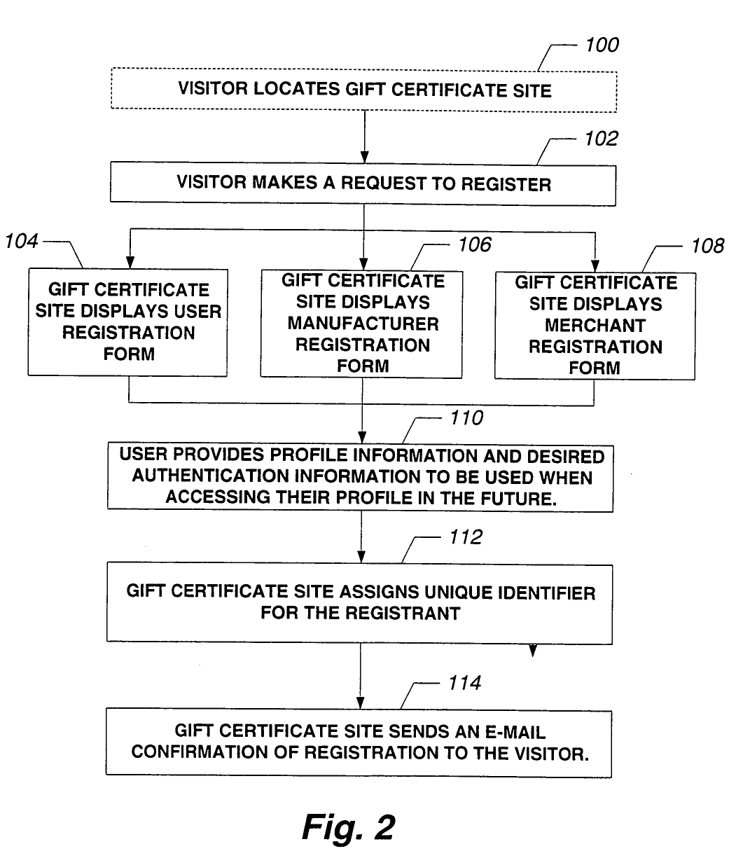

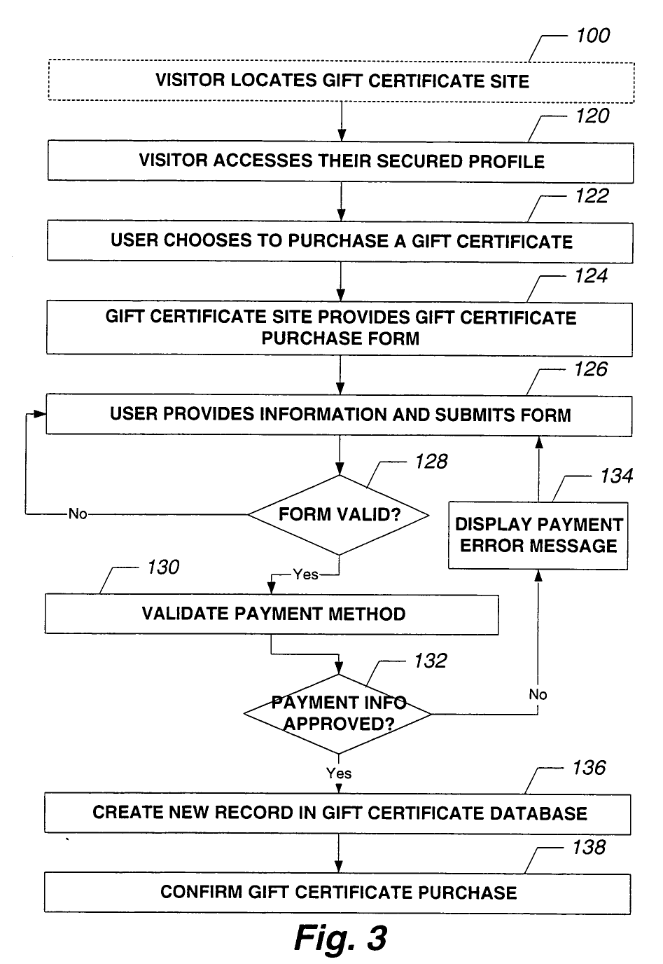

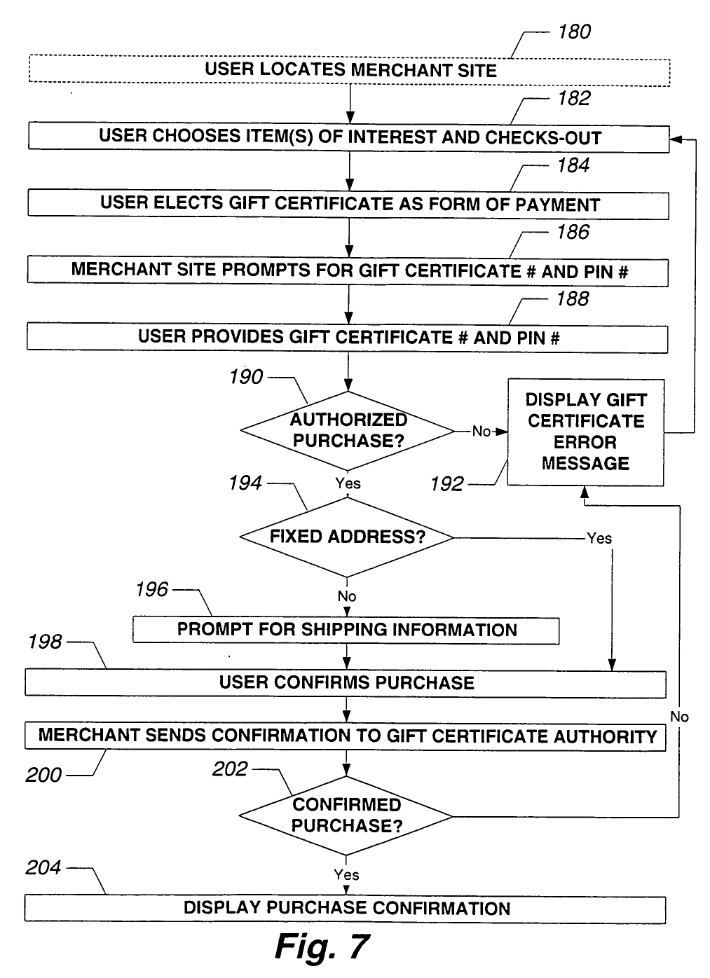

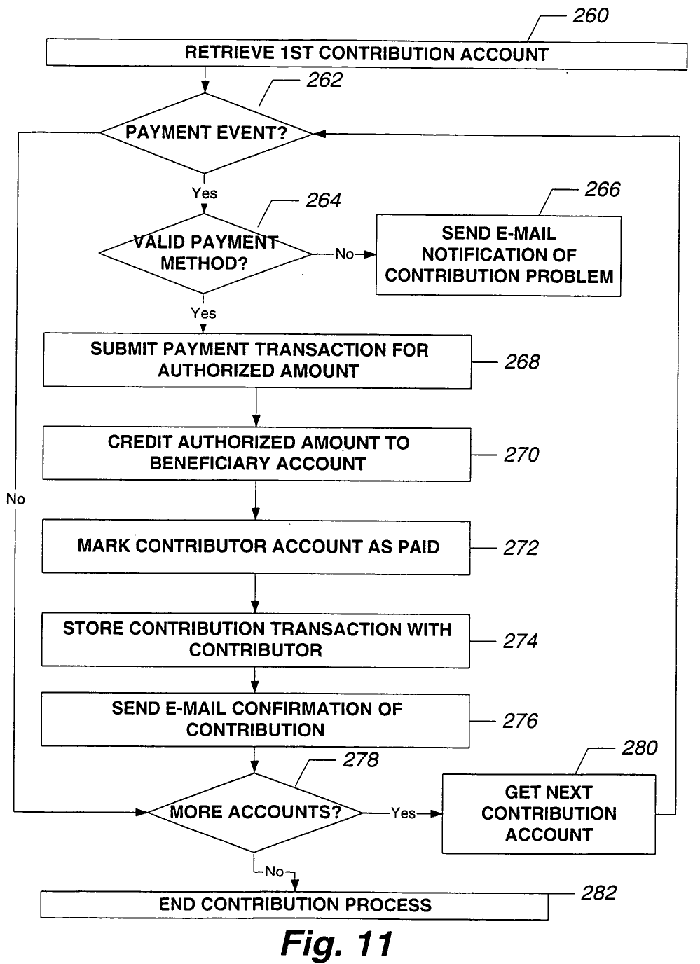

To facilitate a complete understanding of invention, the remainder of the detailed description is arranged as follows: The basic components and features of the preferred embodiments will be initially be described with reference to FIG. 1 under the heading GENERAL ARCHITECTURE. Registration of users, merchants, and manufacturers will be described with reference to FIG. 2 under the heading USER, MERCHANT, AND MANUFACTURER REGISTRATION PROCESSES. The processes that a registrant can perform are described with reference to FIGS. 3 through 6 under the heading REGISTRANT PROCESSES. The redemption of the gift certificate is described with reference to FIGS. 7 through 10 under the heading GIFT CERTIFICATE REDEMPTION PROCESSES. The Contribution process is described with reference to FIG. 11 under the heading CONTRIBUTION PROCESS.

2. General Architecture (FIG. 1)

FIG. 1 illustrates the basic components of a system, which operates in accordance with the present invention. Registered users (also referred to as “consumers” or “registrants) connect to the Internet 40 (or other distributed public network) via user computers 50 to purchase electronic gift certificates, modify their personal profile, make anonymous contributions, or redeem electronic gift certificates at multiple merchant sites 60. Merchant sites 60 communicate with the Gift Certificate Authority 80 to authenticate the gift certificates and to redeem the certificates on the user's behalf.

The registered users may connect to the Internet 40 in any known manner. For example, the users may us a suitable online services network to obtain access to the Internet, or may connect by establishing an account with an Internet Service Provider (not shown). Each user computer 50 includes at least one client application 52 (such as a World Wide Web browser) for communicating with server application on the Internet 40.

The Merchant services are provided on the individual Merchant sites 60 of registered Partners. Each Merchant site 60 will typically comprise one or more physical servers that are connected to the Internet 40. Each Merchant site 60 runs at least one server application 62 for providing an online service. A given Merchant site 60 may, of course, provide multiple online services. Some of these services may be non-commerce-related services that are provided for free. For purposes of the following description, it may be assumed that the term “Merchant service” refers only to fee-based services. Additionally, it may be assumed that the term “registrant” and the term “Partner” refers only to registered users and Merchants respectively. The terms “gift certificate purchasers” and “gift certificate redeemers” may refer to registered users or non-registered users.

Although the user computers 50 and the Merchant sites 60 are shown as being directly connected to the Internet 40, it should be understood that such connection may be via one or more private networks. For example, a user computer 50 may connect to the Internet 40 via a wireless connection or via a private cable televisions network using a cable modem. Likewise, a Merchant site may connect to the Internet via a private network of the merchant's organization.

Merchant sites 60 may offer various types of services. These services may include retail merchandise, as well as digital products and/or informational or subscription-based services or wholesale purchases. For example, one Merchant may offer clothing products for sell, another one sporting goods, while still another one downloadable software. Other Merchant services may include, for example, investment advice services, electronic publications, travel-related services, or consultation. It is anticipated that as user access speeds to the Internet increase, higher bandwidth services such as interactive games, movies-on-demand, and hi-fi audio will be made available. Furthermore, these services may also include business-to-business services such as procurement or consultation.

The Merchants are free to offer any product or service that they desire and are free to select any appropriate method of payment for their services rendered. For example, items of interest may include a given amount of time on a given service, or, in the case of a publication subscription or software download, a one-time fee.

With reference to FIG. 1, each Merchant site additionally includes a Gift Certificate Agent 64, which authenticates an electronic gift certificate with the Gift Certificate Authority. The Gift Certificate Agent 64 server components are preferable in the form of software modules, which include the necessary logic for sending the items in an encrypted format to the Gift Certificate Authority 80. These software components may also contain payment processing.

Upon the shopper checking out of the Merchant's site and redeeming their gift certificate, the Merchant site 60 obtains authentication information from the shopper and transmits this information to the Gift Certificate Authority for approval via the Gift Certificate Agent 64. The Gift Certificate Authority 80 then validates this information against the Gift Certificate Database 86. If all optional restrictions placed on the use of the gift certificate are met, the certificate is still current, and the requested amount is less than or equal to the credited amount, then the Gift Certificate Authority 80 sends a successful result code back to the Merchant Site 60. Otherwise, different result codes are sent back depending upon the reason for refusal. If successful, the appropriate amount is deducted from the remaining amount and a sales transaction is associated with that certificate in the Gift Certificate Database 86.

Sales Transaction information may contain but is not limited to the associated merchant that the purchase was made from, product information including Manufacturer ID, UPC Code, Merchant Code, Merchant Product Code, Product Description, Quantity, Unit Prices, and Order Totals including shipping and handling and taxes. All typical information that is associated with an online order is provided and stored with the transaction. This information is common knowledge in the industry.

The Manufacturer Site 70 preferably comprises one or more physical servers that run a Manufacturer Server Application 72. The Manufacturer Site 70 communicates with the Gift Certificate Authority 80 to provide product catalog information and a list of their resellers. The preferred embodiment of this information is in the form of XML (extensible Markup Language), which is becoming popular for business-to-business communication in the industry.

With further regards to FIG. 1, The Gift Certificate Authority site 80 preferably comprises one or more physical servers that run a Gift Certificate Registrar application 82 to implement the Gift Certificate Service. The site 80 is preferably operated by a single business, or a small collection of businesses, that are qualified to perform gift certificate and contribution services on behalf of users, manufacturers and Merchants. As described below, the Gift Certificate Authority Site 80 may communicate with the Merchant sites 60 (to provide targeted audiences interested in items of interest) either via the Internet (or other public network), a private network, a private communications channel, or a combination thereof.

Although a single Gift Certificate Authority site 80 is shown in FIG. 1, it will be recognized that multiple Gift Certificate Authority sites could be provided on the Internet 40. For example, Gift Certificate sites may be set up at several different geographical locations to accommodate Merchant sites 60 located in different regions. Additionally, as with the user computers 50 and the Merchant sites 60, the Gift Certificate site 80 may be connected to the Internet 40 via one or more private networks.

The Gift Certificate site 80 includes one or more physical databases for storing various account information with respect to the users, manufacturers, and merchants. This information preferably includes the passwords and profiles.

Contribution accounts may be setup to allow anonymous contributions to beneficiaries. These accounts can automatically transfer funds upon some reoccurring schedule if desired or when requested.

Finally, the brokering site 80 may store, and make available to the merchants and manufacturers, certain aggregate marketing information that can be used to tailor their respective services and products.

3. User, Merchant, and Manufacturer Registration Process (FIG. 2)

FIG. 2 illustrates the basic steps that take place, in accordance with the invention, when a user, manufacturer, or a merchant registers at the Gift Certificate site 80. In FIG. 2, the box shown in dashed lines represents an optional step, which may or may not be performed (depending upon the particular actions taken by the visitor).

With reference to block 100 in FIG. 2, the visitor initially locates the Gift Certificate Service by obtaining the location information of the corresponding Gift Registry site 80. This location information may be in a variety of forms, such as a Uniform Resource Locator (URL), a Domain Name Service (DNS) name, or an Internet Protocol (IP) address.

With reference to block 102, if a visitor makes a request to register with the Gift Certificate system, the system displays either 104 the User Registration Form, or 106 the Manufacturer Registration Form, or 108 the Merchant Registration Form depending upon the type of visitor registering. They then provide 110 profile information and an associated password and password hint to be used when accessing their profile in the future. The password hint is displayed to the user if they forget their password. If they are still unable to login to their profile, then they can request that an email message be sent to their registered email address with the associated password. This is a standard practice used on online sites to assist the user in remembering their password for access to the site. The Gift Certificate system assigns 112 a unique identifier to be used later for identification. Upon the storing of the new registrant profile, the Gift Registry system will send 114 an e-mail confirmation of the registration to the user.

Depending upon the type of registrant (i.e. User, Manufacturer, or Merchant), the profile information is stored in the User Database 88, Manufacturer Database 90, or the Merchant Database 92.

4. Registrant Processes (FIGS. 3, 4, 5, 6)

The preferred gift certificate purchase process is illustrated in FIG. 3, in which the visitor first locates 100 the Gift Certificate Authority. This may be from search engines, reciprocal links, e-mails, or other forms of advertising. The visitor then must access 120 their secured profile. Once logged on, the registrant can elect to purchase a gift certificate. If the registrant elects 122 to purchase a gift certificate, the Gift Certificate site provides 124 them with a purchase form. Once the user provides the appropriate information and submits 126 the form, the system will check 128 to make sure that the form has all the required fields and pass all validation rules. If the information is not complete and correct, the user will be shown appropriate error messages and be given another chance to correct the information.

If the provided information is complete and correct, then their payment method will be validated 130. This may be either a charge for the requested amount to their credit card, a mailed check, company invoice, or other form of electronic cash or wire transfer. If there is an error in the payment, then the system will display 134 a Payment Error Message and allow the user to re-enter the payment information again to correct any mistakes that may have been made. Otherwise, if the payment was successful, then a new gift certificate is issued, by creating 136 a new record in the Gift Certificate Database 86. Once a new record is created, the system confirms 138 the process by display a Confirmation Page and sending an e-mail confirmation to the registered e-mail address for the account.

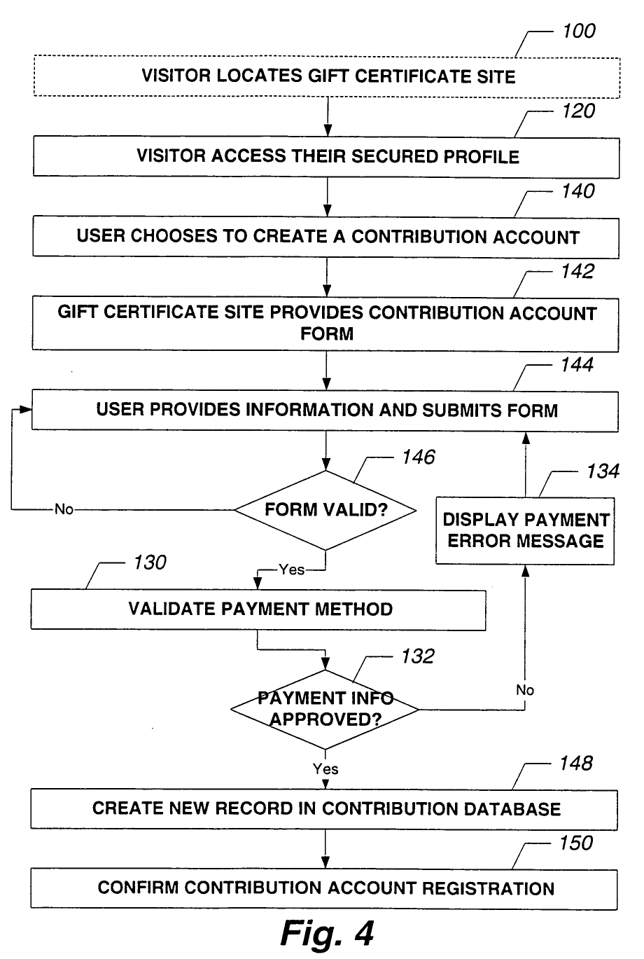

In regards for FIG. 4, a user may also elect to create a contribution account if they so desire. The user must first log on to their secured account as described above and then choose 140 to create a contribution account. The Gift Certificate site 80 then provides 142 a Contribution Account Form for the user to provide 144 the required information such as billing and contribution frequency. Once the user is satisfied, they submit 144 the form and the system checks 146 to make sure that the form is valid (i.e. Complete and all required fields entered). If the form is not valid, the user has the opportunity to correct any mistakes.

If the form is valid, then the system tries to validate 130 their payment method as described earlier. If unsuccessful 132, the system will display 134 a Payment Error message. Otherwise, if the payment method is approved, a contribution account will be setup by creating a new record 148 in the Contribution Account Database 84. If the user chose immediate contribution, then they will be charged appropriately and the contribution will be credited to the appropriate beneficiary's account. If the user chooses a future contribution on a given date or reoccurring basis, then their account will be setup appropriately.

Once their contribution account is setup, the system will confirm 150 the registration by displaying a Contribution Registration Confirmation Page in addition to sending an e-mail confirmation to the registered e-mail address.

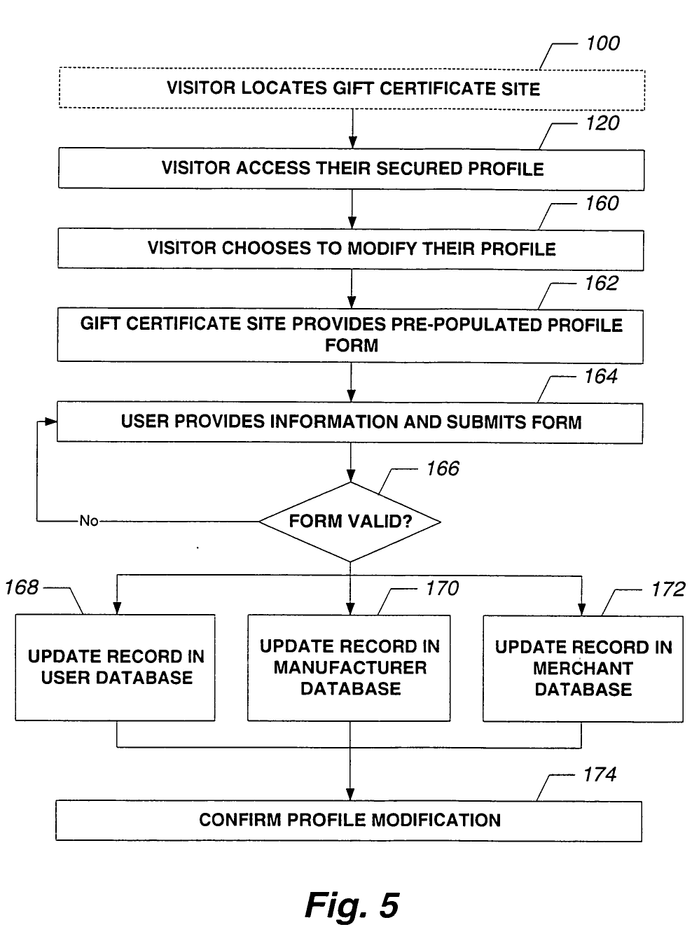

FIG. 5 shows the process for a visitor to update their online profile. After locating the Gift Certificate site 80 and logging on to their secured profile as describe earlier, the visitor may elect to modify their profile. If the visitor chooses 160 to modify their profile, the system provides 162 a pre-populated form of all the current information related to their profile. The user may modify and incorrect information and submit the form 164, after which, the system will check 166 the form for validity as defined earlier. If the form is not valid, the user is given the opportunity to make corrections. Otherwise, if the form is valid, then the appropriate record is updated by the system. Depending on the type of user, the system updates 168 the User Database 88, or updates 170 the Manufacturer Database 90, or updates 172 the Merchant Database 92. The system then displays a Profile Modification Confirmation page for the user.

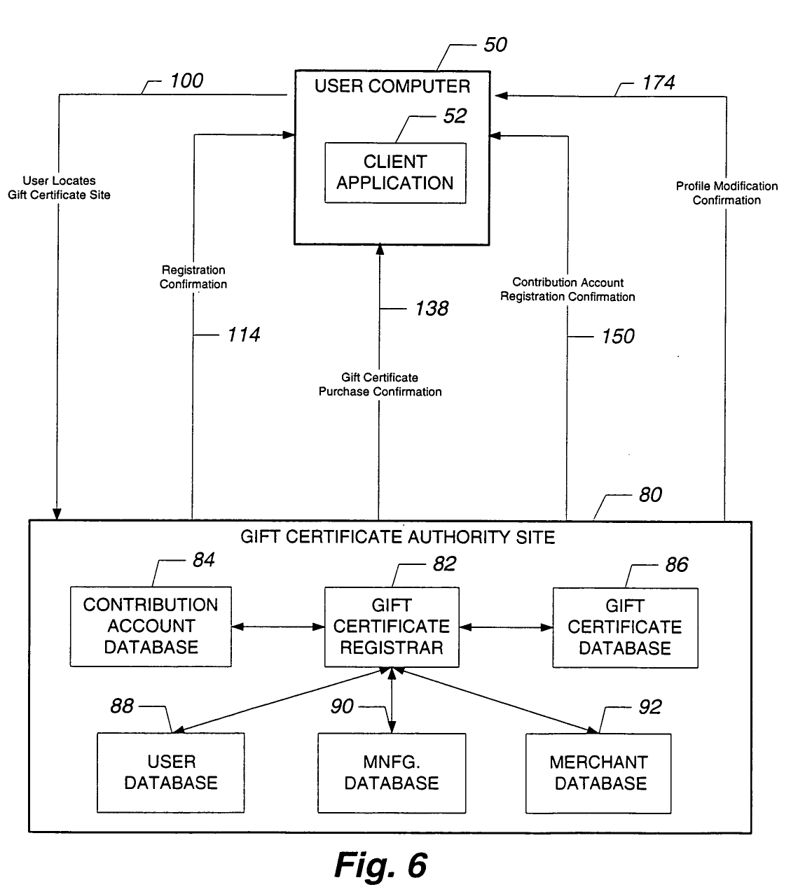

The communication paths between the User Computer 50 and the Gift Certificate Authority 80 are shown in FIG. 6. The user begins any function by first locating the site 100. After performing any online action, the Gift Certificate site 80, sends confirmation e-mail to the User Computer 50.

5. Gift Certificate Redemption Processes (FIGS. 7, 8, 9, 10)

The preferred gift redemption process is illustrated in FIG. 7, in which the User locates 180 a Merchant site by obtaining the location information of the corresponding Merchant site 60. As indicated earlier, this location information may be in a variety of forms, such as a Uniform Resource Locator (URL), a Domain Name Service (DNS) name, or an Internet Protocol (IP) address. The user may optionally obtain this information about a participating Merchant via a link on the Gift Certificate site 80. Of course, the user may already have this information from a previous session, or may obtain this information using another Internet directory service or search engine. While browsing the Merchant's site, the user chooses items of interest and later decides the purchase the items by checking out.

After choosing 184 to use their gift certificate as a form of payment, the Merchant site 60 prompts 186 the user for their gift certificate # and PIN #. The Merchant site 60 then provides this information as well as additional information such as their Merchant ID and the category of product being purchased, and age range, to the Gift Certificate site 80 via the Gift Certificate Agent 64. The Gift Certificate site 80 will then send back a status on whether the purchase is authorized or not 190 and a shipping address if a fixed address is associated with this certificate. If the purchase was not authorized, the Merchant site 60 will display 192 the Gift Certificate Error Message. Otherwise, the Merchant Server Application 62, will then check and see if the Gift Certificate Registrar 82 provided a fixed address. If yes, then the user will be simply asked to confirm 198 their purchase. If not, then the user will be prompted 196 for their shipping address before confirming 198 their purchase.

Once the user confirms 198 their purchase, the Gift Certificate Agent 64 on the Merchant Site 60 sends 200 a confirmation to the Gift Certificate Registrar 82. The Gift Certificate Registrar will then respond with either a confirmed purchase or not. If the purchase was not confirmed 202, then the Merchant system will display 192 the Gift Certificate Error Message. Otherwise, the Merchant system will display a Purchase Confirmation page and send an e-mail confirmation to the registered e-mail associated with the gift certificate.

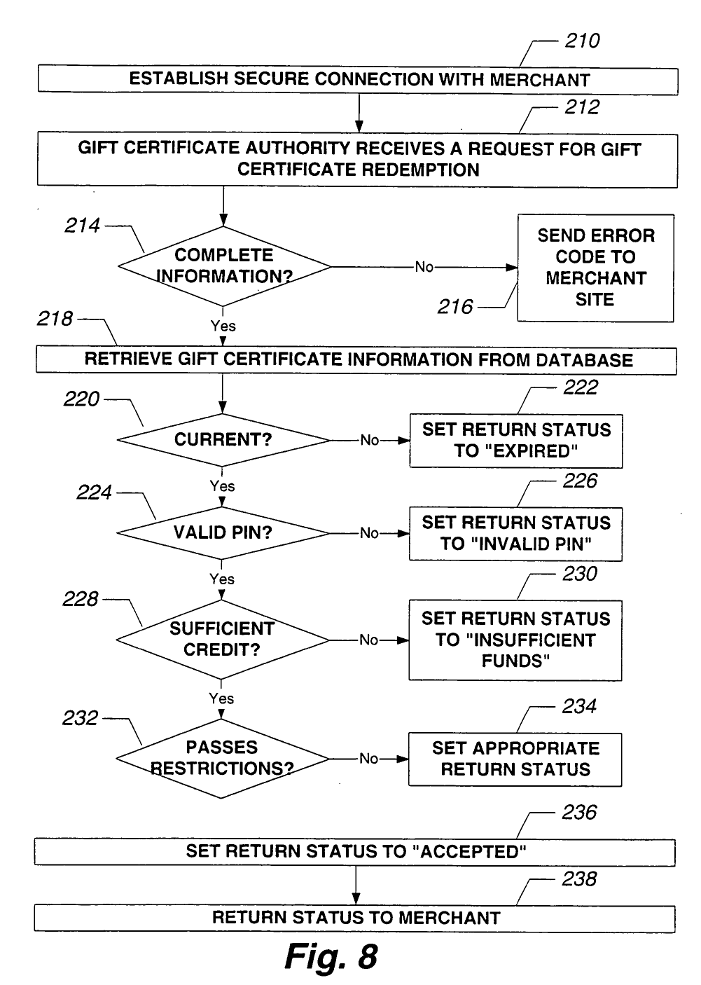

FIG. 8 shows the process of validating a gift certificate for use on a purchase. After establishing 210 a secure connection with a merchant, which is defined in greater detail below, the Gift Certificate Authority 80 receives 212 a request for gift certificate redemption. The first thing that is checked is to see if all the appropriate information was provided 214. If not, then an appropriate error code is sent back 216 to the Merchant site 60. Otherwise, the system will retrieve 218 the associated information related to the specified gift certificate. Then a check is made to see if the gift certificate is current 220. If not, then the return status is set to “Expired” 222 and returned to the merchant's system. If yes, then a check is made to see if a valid PIN # was provided 224. If not, then the return status is set to “Invalid PIN” 226 and returned to the merchant's system. If yes, then a check is made to see if there is sufficient credit 228. If not, then the return status is set to “Insufficient Funds” 230 and returned to the merchant's system. If yes, then a check is made on any restrictions that are associated with the user of the certificate to see if the provided information passes the restrictions 232. If not, then the return status is set to an appropriate return message on what restriction is blocking the purchase. Otherwise, if all the checks are passed, then a return status of “Accepted” 236 is set and the return status is sent 238 back to the merchant's system.

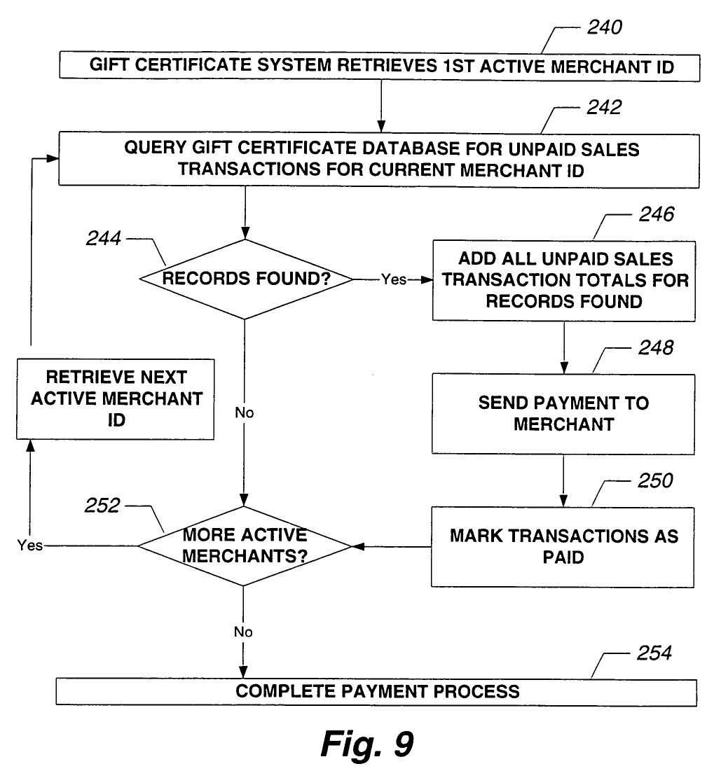

A periodic batch process that handles the billing system is shown in FIG. 9. It begins by the Gift Certificate system retrieving 240 the 1st active merchant ID. This merchant ID is then used to query 242 the Gift Certificate Database 86 for unpaid sales transaction for that merchant. A check is then made 244 for any records found. If not, then the process continues by looking to see if there are any more 252 active merchants. If there were records found, then all the unpaid sales transaction totals 246 are added to form a grand total for amount owed. This amount is then send 248 to the merchant. The preferred embodiment would be an electronic funds transfer, but may result in physical checks being generated and mailed for some merchants. Next, these transactions will be marked as paid 250. If there are more active merchants 252, then the process repeats. If not, then the process is completed 254.

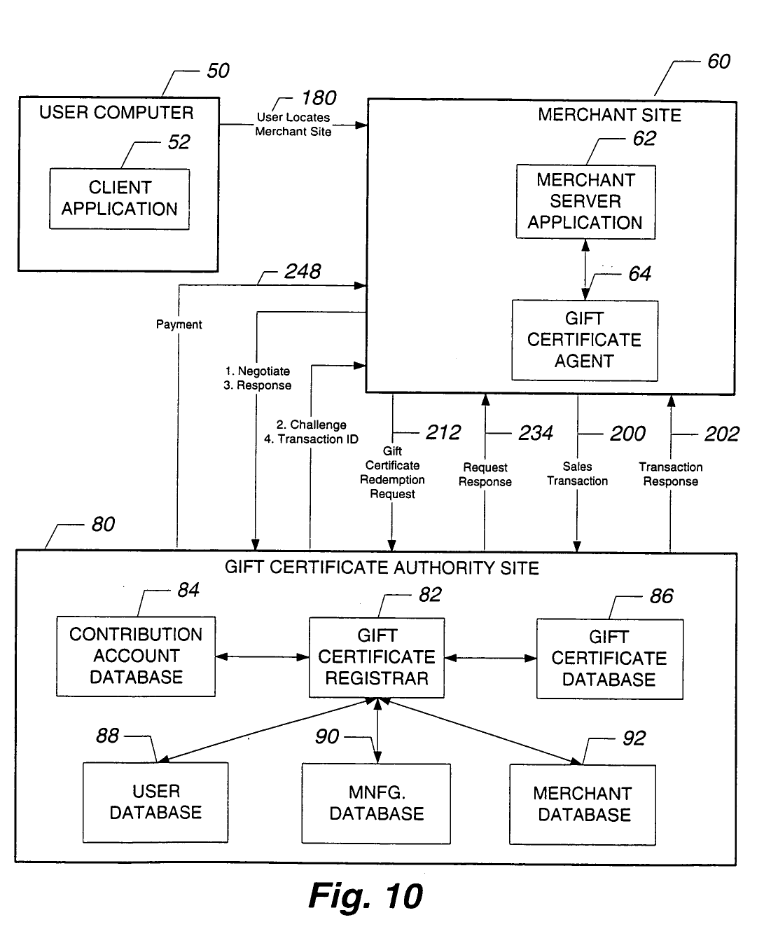

The communication path between the User Computer 50, the Merchant Site 60, and the Gift Certificate Authority 80 in regards to the gift certificate redemption process is shown in FIG. 10. The User begins by locating 180 the Merchant Site 60. Upon the user choosing to use a gift certificate as payment, the Merchant Server Application 62 establishes a secure communication link with the Gift Certificate site 80. This involves the transmission of a “negotiate” message from the Merchant Server Application 62 to the Gift Certificate Registrar 82. This negotiate message includes the Merchant's unique ID, which may be in the form of a digital certificate. The Gift Certificate Registrar 82 on the Gift Registry Site 80 responds to the negotiate message by sending a pseudo-random “challenge” message to the Merchant's Gift Certificate Agent 64.

In response to the challenge message, the Gift Certificate Agent 64 software generates and returns a cryptographic “response” message, which is based on both the challenge message and the SP's password.

The above-described method of requesting authentication is commonly referred to as a “challenge-response authentication” protocol and is widely understood in the industry. It is shown in FIG. 10 with the numbered arrows 1-4 indicating the order in which these messages are passed. For more detailed information, see Rivest, R., “The MD4 Message Digest Algorithm,” Proceedings, Cryptop '90, Springer-Verlag, August 1990. For a description of other cryptographic algorithms, which may be used, see Stallings, W., Network and Internetwork Security, Prentice Hall, 1995.).

With reference to FIG. 10, if the Merchant site is successfully authenticated, the Gift Certificate Agent 64 may perform one of two actions. The first action that may be performed is the sending 212 of a gift certificate redemption request to the Gift Certificate Registrar 82 of the Gift Certificate Authority 80. This request must provide information to check against any restrictions placed on the gift certificate's use. The Gift Certificate Registrar 82 sends an appropriate request response 234 back depending upon whether the request is approved or not. Likewise, the second action is a follow-on to the first action to confirm the Sales Transaction 200. Also, similar to the first action, the Gift Certificate Registrar 82 sends back a transaction response 202.

6. Contribution Processes (FIG. 11)

With reference to FIG. 11, the Gift Certificate system periodically, processes payments to beneficiaries from contribution accounts. The system begins by retrieving 260 the 1st contribution account from the Contribution Account Database 84. A check is made on whether a payment should be made 262 from the current contribution account. If not, then the system will look for any additional active accounts 278. Otherwise, a check will be made on whether the payment method is valid 264. The preferred method is a charge against their credit card, but other forms of payment may be mailed checks, or other forms of electronic payment. If there is a problem with the contribution, then an appropriate e-mail will be sent 266 to the registrant of the account notifying them of the problem allowing them to correct the issue.

If the payment is valid, then the payment transaction 268 is submitted for the authorized amount. As part of the same transaction, the beneficiary account is credited 270 for the same amount. Note that these two transactions should occur as a single logical transaction. If either transaction fails, then the entire logical transaction should be rolled back without any changes being made. If successful, mark 272 the contributor account as paid and then store 274 a record of the transaction in the Contribution Account Database 84. Finally, send an e-mail 276 confirmation to the register e-mail associated with the account.

The process continues by looking and seeing if there are more accounts that should be processed 278. If yes, then the next contribution account is retrieved 280 and the process is repeated. Otherwise, the process is completed 282.

### INDUSTRIAL APPLICABILITY

Thus the reader will see that the Gift Certificate site defined in this invention provides a highly efficient and convenient method of purchasing and using gift certificates by a plurality of registered merchants. Furthermore, this invention has the additional advantages in that:
It permits the gift certificate purchaser to limit and track purchases made with the gift certificate by the recipient if appropriate.
It permits anonymous shopping rather than the user supplying personal financial information for verification.
It allows those who are unable to get a credit card to still perform online purchases.
It permits a single certificate to be split across multiple purchases at a plurality of merchants.
It reduces the possibility of credit card fraud.
It allows anonymous contributors to beneficiaries.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

1. a system for providing an electronic gift certificate service over a distributed network, comprising of:
a plurality of Merchant sites connected to the distributed network, each Merchant site running at least one service application to provide an online service to users over the distributed network;
a plurality of Manufacturer sites connected to the distributed network, each Manufacturer site running at least one service application to provide an online service to users over the distributed network;
a plurality of user computers connected to the distributed network, each user computer running at least one client application for accessing online service of the Merchant sites;
a Gift Certificate Authority site connected to the plurality of Merchant and Manufacturer sites, the gift certificate site including a user database, a manufacturer database, and a merchant database containing authentication information of registrants, the registered users accessing the Merchant sites from the user computers over the distributed network;
a database which stores user-specific customization data, the customization data specifying preferences of the registered users with respect to the online services of the Merchant sites; and
a database which stores contribution information related to registrants and beneficiary information, the contribution information which allows one-time or reoccurring contributions to specified beneficiaries; and
a database which stores the gift certificates and related transactions; and
a database which stores Merchant information, the Merchant information specifying communication information necessary for establishing secure connections between the Merchant and the Gift Certificate system; and
a database which stores Manufacturer information, the Manufacturer information contains the relationships of which resellers sell the manufacturers products; and
an authentication protocol for allowing the gift certificate site to authenticate users, manufacturers, and merchants and communication links with the partner systems, the authentication protocol implemented by software components of the Manufacturer, Merchant, and Gift Certificate sites.
Whereby a scaleable system is defined that supports multiple online merchants of any size and from any location in the world.

2. A system as in claim 1, whereby an individual or company may purchase an electronic gift certificate.

3. A system as in claim 2, whereby the purchaser may place restrictions on the use of the gift certificate.

4. A system as in claim 2, whereby the purchaser may track the use of the gift certificate.

5. A system as in claim 4, whereby a search mechanism provides for accessing the sales transactions associated with a gift certificate.

6. A system as in claim 1, whereby an individual or company may contribute to beneficiaries electronically.

7. A system as in claim 6, whereby contributions can be made automatically on a re-occurring basis.

8. A system as in claim 6, whereby contributions can be made anonymously.

9. A system as in claim 1, which allows the electronic gift certificate to be split across multiple purchases at a plurality of merchants.

10. A method whereby gift certificate purchasers my place restrictions on the use of that certificate, comprising the steps of:
Indicating interest to purchase electronic gift certificate;
Entering the desired dollar amount to be applied to the gift certificate;
Entering a PIN # for authentication in the redemption process;
Optionally, entering any restrictions on use;
Providing payment information to Gift Certificate site;
Gift Certificate site validating payment information;
Confirming the order;
Receiving an Order Confirmation, the order confirmation being shown via online display immediately and later e-mail notification;
Whereby a gift certificate purchaser can make a purchase in a timely manner from the convenience of their home or office and the purchaser's privacy is maintained.

11. A method as in claim 10, wherein the gift certificate purchaser may associate a fixed Shipping Address with the said use of the gift certificate.

12. A method as in claim 10, wherein the use of a gift certificate may be restricted by category of product or service.

13. A method as in claim 10, wherein the use of a gift certificate may be restricted by age range of product or service.

14. A method as in claim 10, wherein the use of a gift certificate may be restricted by dollar limitations on a per order or per item basis.

15. A method as in claim 10, wherein the use of a gift certificate may be restricted to a given date range.

16. A method as in claim 10, wherein the use of a gift certificate may be restricted to a given merchant or group of merchants.

17. A method whereby the registrant may contribute electronically to beneficiaries on a reoccurring basis.

18. A method as in claim 17, wherein a contribution can be made anonymously.

19. An apparatus comprising:
A Gift Certificate Authority server operatively connected to a computer network, the server having a processor and a computer readable memory, the memory storing gift certificate and contribution implementation software, including database management software, customer access software, payment processing software, and artificial intelligence software;
at lease one data structure including a list of registrants along with corresponding ID and profile information, and including a list of participating manufactures with their corresponding communication information, and including a list of participating merchants with their corresponding communication information, the list of participating merchants being a subset of the sites available to users of the computer network, the at least one data structure further including the registration of gift certificates, and contributions;
a first data entry system through which information about registrants are entered into the computer system, the first information for each registrant including at least a first name, last name, and e-mail address, which the registrant has been assigned a unique identifier;
A second data entry system capable of receiving second information, the second information including a list of gift certificates which the registrant has purchased and related sales transactions;
A database storage system that stores and retrieves the first and second information about the registrant; and
A third data entry system through which information about Merchants are entered into the computer system, the third information for each merchant including at least a contact name and e-mail address;
A fourth data entry system through which information about Manufacturers are entered into the computer system, the fourth information for each manufacturer including at least a contact name and e-mail address and preferably corresponding resellers;
The database storage system, which also includes “contributions” in addition to the gift certificates;
whereby the gift certificate service facilitates seamless connection between gift certificate purchasers and redeemers and registered merchants for the purchasing of items and making contributions to beneficiaries.

20. The gift certificate authority as in claim 19 wherein the first, second, third, and fourth data entry system comprises a client application running on a user computer;

21. The gift certificate authority as in claim 19 further comprising updating means for updating the database storage system as a prospective purchaser buys a gift certificate, modifies their profile, creates a contribution account, or modifies their contribution account.

22. The gift certificate authority as in claim 19 further comprising a database storage system which resides on one or more computers at one or more sites that work in tandem.
